(19) United States
(12) Patent Application Publication
(10) Pub. No.: US 2021/0325534 A1
(43) Pub. Date: Oct. 21, 2021

(54) MEASUREMENT METHODS, MEASUREMENT DEVICES, AND STORAGE MEDIUMS

(71) Applicant: FUJITSU LIMITED, Kawasaki-shi (JP)

(72) Inventors: Katsushi Sakai, Zama (JP); Koichi Tezuka, Shibuya (JP); Koichi Iida, Kobe (JP); KOSUKE YANAI, Kawasaki (JP)

(73) Assignee: FUJITSU LIMITED, Kawasaki-shi (JP)

(21) Appl. No.: 17/193,599

(22) Filed: Mar. 5, 2021

(30) Foreign Application Priority Data
Apr. 20, 2020 (JP) 2020-074486

(51) Int. Cl. G01S 17/08; G01S 17/894; G01S 7/4865

(52) U.S. Cl. CPC G01S 17/08; G01S 7/4865; G01S 17/894

(57) ABSTRACT

A measurement method executed by a computer, the method includes executing transmission processing and measuring processing, the transmission processing including a process of notifying a first signal instructing light emitting processing and the measuring processing, the measuring processing including a process of identifying a distance by measuring a time from a reception time of the first signal; setting a communication path for notifying a second signal output by the transmission processing to the measuring processing via a transceiver for transmitting a synchronization signal, the synchronization signal being for notifying an external measurement device of a light emission output by the light emitting processing; and identifying a timing for transmitting the synchronization signal output by the transmission processing based on a time difference between a time for receiving the second signal not through the transceiver and a time for receiving the second signal via the transceiver.

### CROSS-REFERENCE TO RELATED APPLICATION

This application is based upon and claims the benefit of priority of the prior Japanese Patent Application No. 2020-74486, filed on Apr. 20, 2020, the entire contents of which are incorporated herein by reference.

### FIELD

Embodiments discussed herein are related to measurement methods, measurement devices, and a storage medium, BACKGROUND

Techniques for synchronizing a plurality of devices have been disclosed. Japanese Laid-open Patent Publication No. 08-279838 and the like are disclosed as related art, for example.

### SUMMARY

According to an aspect of the embodiments, a measurement method executed by a computer, the method includes executing transmission processing and measuring processing, the transmission processing including a process of notifying a first signal instructing light emitting processing and the measuring processing, the measuring processing including a process of identifying a distance by measuring a time from a reception time of the first signal; setting a communication path for notifying a second signal output by the transmission processing to the measuring processing via a transceiver for transmitting a synchronization signal, the synchronization signal being for notifying an external measurement device of a light emission output by the light emitting processing; and identifying a timing for transmitting the synchronization signal output by the transmission processing based on a time difference between a time for receiving the second signal not through the transceiver and a time for receiving the second signal via the transceiver.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an entire configuration of a measurement system according to a first embodiment;

FIGS. 2A and 28 are diagrams each illustrating an example configuration of a transceiver/receiver;

FIG. 3 is a diagram illustrating an example light reception period of a first measurement device and an example light reception period of a second measurement device;

FIG. 4 is a diagram illustrating an example synchronization delay;

FIGs. 5A and 5B are diagrams illustrating wiring paths in a non-measurement mode;

FIG. 6 is a diagram illustrating an example of synchronization correction;

FIG. 7 is a flowchart showing an example operation of the first measurement device;

FIGS. 8A and 8B are diagrams illustrating an example operation of the first measurement device;

FIG. 9 is a block diagram for explaining the hardware configuration of a signal transmitting unit and a measuring unit;

FIG. 10 is a diagram illustrating a case where the number of measurement devices is three or larger;

FIG. 11 is a diagram illustrating a gymnastics competition venue; and

FIG. 12 is a diagram illustrating the layout of measurement devices.

### DESCRIPTION OF EMBODIMENTS

However, measurement devices that measure distances by emitting and receiving light have been developed. Measurement devices are synchronized with one another, and carry out measurement in a sequential manner, so that measurement such as high-precision 3D sensing can be conducted. If synchronization accuracy is insufficient among such measurement devices, light interference might occur among the measurement devices, resulting in a decrease in measurement accuracy.

In view of the above, it is desirable that measurement accuracy can be increased.

With the progress of IoT, the number of measurement systems that acquire various kinds of data by linking measurement devices to one another is increasing year by year. As measurement devices to be used in such measurement systems, laser imaging detection and ranging (Lidar) devices have been developed, for example.

For high-precision real-time control among measurement devices, technologies using global positioning system (GPS) and technologies for achieving time synchronization using a TIME server, and the like have been developed. However, synchronization to be achieved by these technologies are synchronization on the order of microseconds (10⁻⁶ seconds) at the fastest.

Therefore, in an optical distance measurement device or the like on the order of picoseconds (10⁻¹² seconds), even a delay time in the devices and the wiring lines used for synchronization is not to be ignored. If synchronization delay accuracy is insufficient, the light transmission timing is not controlled among the measurement devices, and light interference might occur.

In the embodiments described below, measurement methods, measurement devices, and measurement programs that can increase synchronization accuracy will be explained.

### First Embodiment

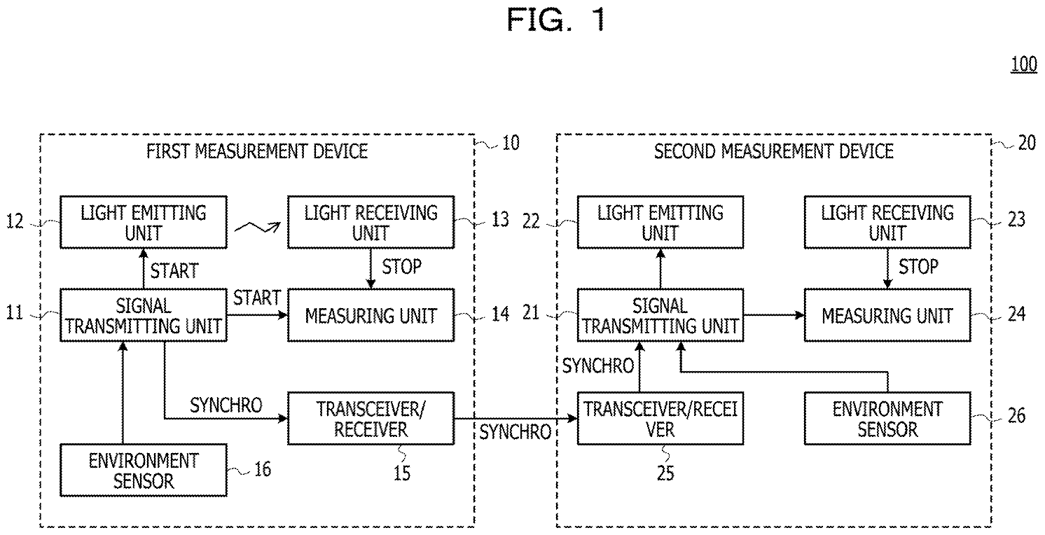

FIG. 1 is a block diagram illustrating an entire configuration of a measurement system 100 according to a first embodiment. As illustrated in FIG. 1, the measurement system 100 includes a first measurement device 10 and a second measurement device 20.

The first measurement device 10 includes a signal transmitting unit 11, a light emitting unit 12, a light receiving unit 13, a measuring unit 14, a transceiver/receiver 15, an environment sensor 16, and the like. The second measurement device 20 includes a signal transmitting unit 21, a light emitting unit 22, a light receiving unit 23, a measuring unit 24, a transceiver/receiver 25, an environment sensor 26, and the like.

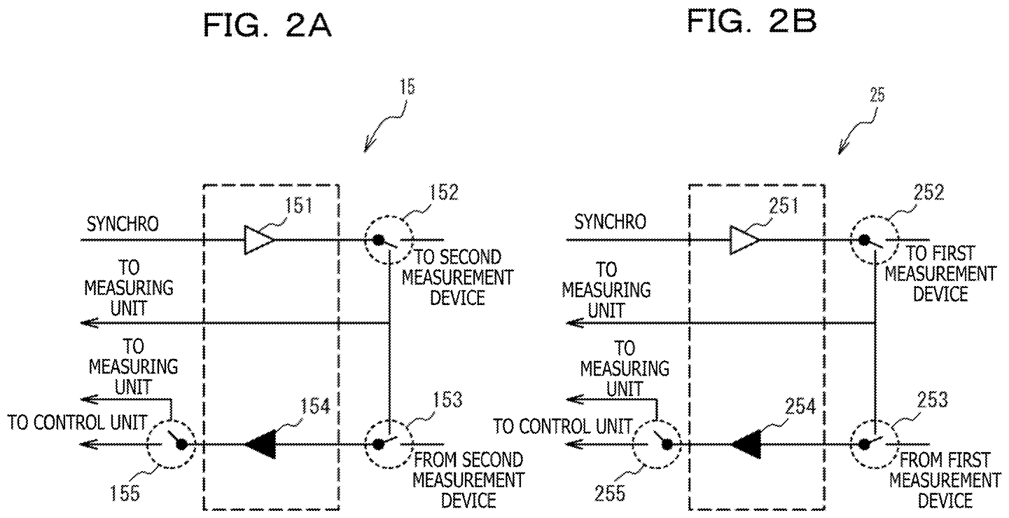

FIG. 2A is a diagram illustrating an example configuration of the transceiver/receiver 15. As illustrated in FIG. 2A, the transceiver/receiver 15 includes a transceiver 151, a switch 152, a switch 153, a receiver 154, and a switch 155. FIG. 2B is a diagram illustrating an example configuration of the transceiver/receiver 25. As illustrated in FIG. 2B, the transceiver/receiver 25 includes a transceiver 251, a switch 252, a switch 253, a receiver 254, and a switch 255.

The switch 152 is a switch that switches between a wiring path between the transceiver 151 and the second measurement device 20, and a wiring path between the transceiver 151 and the switch 153, in accordance with an instruction from the signal transmitting unit 11. The switch 153 is a switch that switches between a wiring path between the receiver 154 and the second measurement device 20, and a wiring path between the receiver 154 and the switch 152, in accordance with an instruction from the signal transmitting unit 11. The switch 155 is a switch that switches between a wiring path between the receiver 154 and the signal transmitting unit 11, and a wiring path between the receiver 154 and the measuring unit 14, in accordance with an instruction from the signal transmitting unit 11.

The switch 252 is a switch that switches between a wiring path between the transceiver 251 and the first measurement device 10, and a wiring path between the transceiver 251 and the switch 253, in accordance with an instruction from the signal transmitting unit 21. The switch 253 is a switch that switches between a wiring path between the receiver 254 and the first measurement device 10, and a wiring path between the receiver 254 and the switch 252, in accordance with an instruction from the signal transmitting unit 21. The switch 255 is a switch that switches between a wiring path between the receiver 254 and the signal transmitting unit 21, and a wiring path between the receiver 254 and the measuring unit 24, in accordance with an instruction from the signal transmitting unit 21.

A measurement mode in which distance measurement is conducted, and a non-measurement mode in which distance measurement is not conducted are set in the first measurement device 10 and the second measurement device 20. In the measurement mode, the measurement system 100 conducts distance measurement. In the non-measurement mode, the measurement system 100 does not conduct distance measurement.

Measurement mode switching may be performed manually by the user, may be performed during a predetermined period such as at the time of activation, or may be performed in accordance with results of detection performed by the environment sensors 16 and 26. In this embodiment, measurement mode switching is performed in accordance with the results of detection performed by the environment sensors 16 and 26. The environment sensors 16 and 26 are sensors that acquire environment information about the measurement system 100, and may be temperature sensors, humidity sensors, or the like. These environment sensors will be described later in detail.

In the measurement mode of the first measurement device 10 and the second measurement device 20, the switch 152 and the switch 253 form a wiring path between the transceiver 151 of the first measurement device 10 and the receiver 254 of the second measurement device 20. Also, in the measurement mode of the first measurement device 10 and the second measurement device 20, the switch 153 and the switch 252 form a wiring path between the transceiver 251 of the second measurement device 20 and the receiver 154 of the first measurement device 10.

In the measurement mode, the first measurement device 10 and the second measurement device 20 emit light to a distance measurement target and receive return light from the distance measurement target during a predetermined light reception period (the maximum detection period of the light receiving units 13 and 23). The distance measurement target may be either a moving object or a stationary object, and may be an object or a living organism (such as a person). The light reception period of the first measurement device 10 and the light reception period of the second measurement device 20 are set so as to alternate and not to overlap. The light reception period is equivalent to the distance to the object (imaging range). To reduce interference at a time of long distance measurement, the light emission intervals and the light reception periods of the first measurement device 10 and the second measurement device 20 are made longer. However, when a large number of distances are to be measured within a certain time, the light emission intervals are preferably shorter. If the synchronization between the first measurement device 10 and the second measurement device 20 is accurately controlled, any return light from the second measurement device 20 does not return during the light reception period of the first measurement device 10, and any return light from the first measurement device 10 does not return during the light reception period of the second measurement device 20. Thus, erroneous detection is reduced.

When the first measurement device 10 functions as a master device in the measurement mode, the signal transmitting unit 11 sends a light emission signal _{START} to the light emitting unit 12 and the measuring unit 14 at the start of the light reception period, and sends a synchronization signal _{SYNCHRO} to the transceiver 151. As a result, the light emitting unit 12 emits pulsed light toward the distance measurement target, the measuring unit 14 starts measuring time, and the transceiver 151 sends the synchronization signal _{SYNCHRO} to the receiver 254 of the second measurement device 20. When the light receiving unit 13 receives return light from the distance measurement target, the light receiving unit 13 sends a stop signal _{STOP} to the measuring unit 14. As a result, the measuring unit 14 stops measuring time, and calculates the time from the reception of the light emission signal _{START} to the reception of the stop signal _{STOP}. This calculated time corresponds to the time of flight (TOF) since the light emitting unit 12 emitted a laser pulse till the return light was received by the light receiving unit 13. The measuring unit 14 multiplies the calculated time by the speed of light, to calculate the distance from the light emitting unit 12 to the distance measurement target.

When the receiver 254 of the second measurement device 20 receives the synchronization signal _{SYNCHRO} from the first measurement device 10, the receiver 254 sends the synchronization signal _{SYNCHRO} to the signal transmitting unit 21. After a period corresponding to the light reception period of the first measurement device 10 has elapsed since the signal transmitting unit 21 received the synchronization signal _{SYNCHRO}, the signal transmitting unit 21 sends the light emission signal _{START} to the light emitting unit 22 and the measuring unit 24 at the start of the light reception period, and sends the synchronization signal _{SYNCHRO} to the transceiver 251. As a result, the light emitting unit 22 emits pulsed light toward the distance measurement target, the measuring unit 24 starts measuring time, and the transceiver 251 sends the synchronization signal _{SYNCHRO} to the receiver 154 of the first measurement device 10. When the light receiving unit 23 receives return light from the distance measurement target, the light receiving unit 23 sends the stop signal _{STOP} to the measuring unit 24. As a result, the measuring unit 24 stops measuring time, and calculates the time from the reception of the light emission signal _{START} to the reception of the stop signal _{STOP}. The measuring unit 24 multiplies the calculated time by the speed of light, to calculate the distance from the light emitting unit 22 to the distance measurement target.

After a period corresponding to the light reception period of the second measurement device 20 has elapsed since the receiver 154 of the first measurement device 10 received the synchronization signal _{SYCHRO}, the signal transmitting unit 11 sends the light emission signal _{START} to the light emitting unit 12 and the measuring unit 14 at the start of the light reception period, and sends the synchronization signal _{SYNCHRO} to the transceiver 151. By repeating the above operation, the first measurement device 10 and the second measurement device 20 alternately conduct distance measurement.

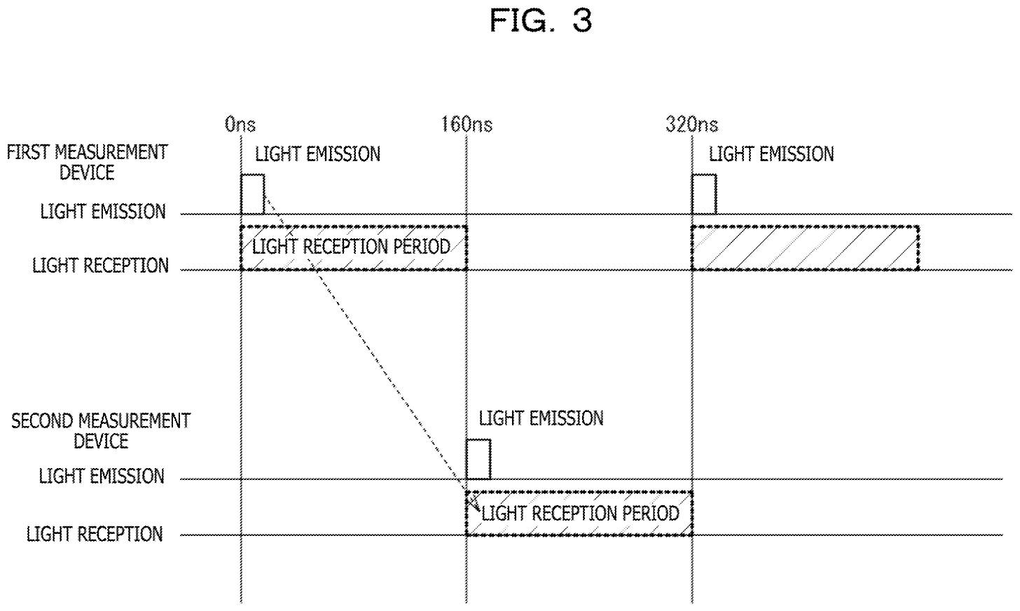

FIG. 3 is a diagram illustrating an example light reception period of the first measurement device 10 and an example light reception period of the second measurement device 20. For example, the light reception period of the first measurement device 10 and the light reception period of the second measurement device 20 are both 160 ns. A light emission cycle of the first measurement device 10 and the second measurement device 20 is 320 ns, which is twice a light reception period.

As described above, the second measurement device 20 neither emits light nor receives light during the light reception period of the first measurement device 10, and the first measurement device 10 neither emits light nor receives light during the light reception period of the second measurement device 20. With this arrangement, light interference between the first measurement device 10 and the second measurement device 20 can be reduced. As a result, the measurement system 100 achieves a higher measurement accuracy.

However, unless the second measurement device 20 is accurately notified of the light emission timing of the first measurement device 10, the light emission pulse of the second measurement device 20 is received by the light receiving unit 13 within the light reception period of the first measurement device 10, depending on the distance between the devices and the distance to the object. For example, due to a delay in each device or the like being used for synchronization, a delay might occur in synchronization between the light emission timing of the first measurement device 10 and the light emission timing of the second measurement device 20.

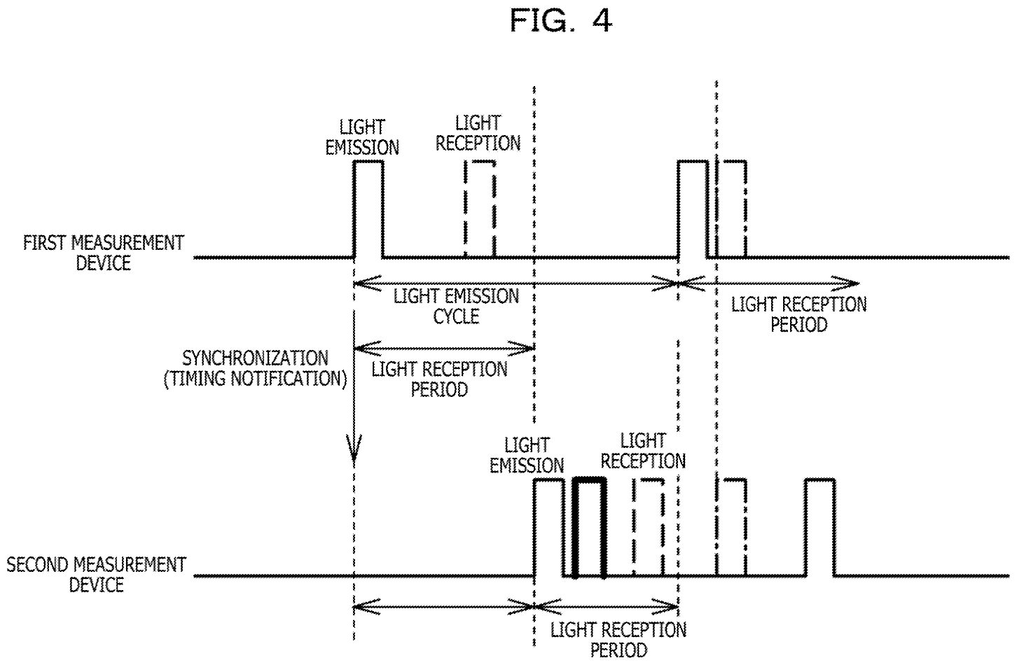

FIG. 4 is a diagram illustrating an example synchronization delay. The light reception period of the first measurement device 10 is a half cycle of a light emission cycle of the light emitting unit 12 of the first measurement device 10. As indicated by a dashed line in the upper portion of FIG. 4, if the light receiving unit 13 of the first measurement device 10 receives light within a half cycle of a light emission cycle, no light interference occurs. However, there are cases where synchronization is delayed, and the timing at which the light emitting unit 22 of the second measurement device 20 emits light (a solid line in the lower portion of FIG. 4) is delayed as indicated by a thick line. In this case, if there is no delay in synchronization, return light is to return at the timing indicated by a dashed line. However, the return light returns at the timing indicated by a dot-and-dash line. Because the timing indicated by the dot-and-dash line falls within the light reception period of the first measurement device 10, the first measurement device 10 performs erroneous detection.

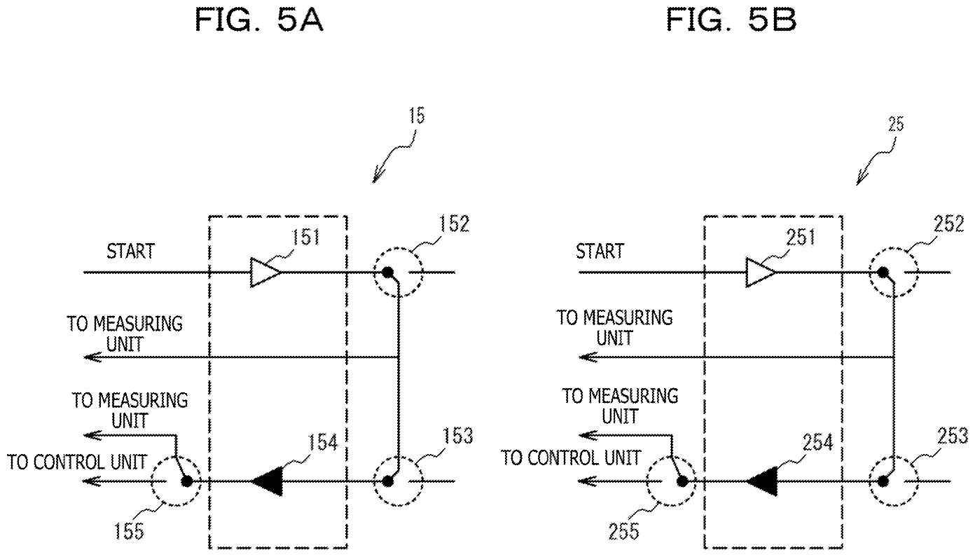

Therefore, as illustrated in FIG. 5A, in the non-measurement mode, the switch 152 forms a wiring path between the transceiver 151 and the switch 153. Further, the switch 153 forms a wiring path between the switch 152 and the receiver 154. The switch 155 forms a wiring path between the receiver 154 and the measuring unit 14. Meanwhile, as illustrated in FIG. 5B, in the non-measurement mode, the switch 252 forms a wiring path between the transceiver 251 and the switch 253. Further, the switch 253 forms a wiring path between the switch 252 and the receiver 254. The switch 255 forms a wiring path between the receiver 254 and the measuring unit 24.

In the non-measurement mode, the signal transmitting unit 11 sends the light emission signal _{START} to the measuring unit 14 and the transceiver 151. Upon receipt of the light emission signal _{START}, the measuring unit 14 starts measuring time. The transceiver 151 sends the received light emission signal _{START} to the switch 152. The switch 152 sends the received light emission signal _{START} to the measuring unit 14 using a branch wiring line between the switch 152 and the switch 153, and also sends the light emission signal _{START} to the switch 153. The switch 153 sends the received light emission signal _{START} to the receiver 154. The receiver 154 sends the received light emission signal _{START} to the switch 155. The switch 155 sends the received light emission signal _{START} to the measuring unit 14.

The time when the measuring unit 14 receives the light emission signal _{START} from the signal transmitting unit 11 is set as time _{START}. The time when the measuring unit 14 receives the light emission signal _{START} that is sent from the switch 152 without passing through the switch 153 is set as time _{STOP1_1}. The time when the measuring unit 14 receives the light emission signal _{START} from the switch 155 is set as time _{STOP1_2}.

The measuring unit 14 calculates the time ΔT1 from time _{START} to time _{STOP1_1}. The measuring unit 14 also calculates the time ΔR1 from time _{STOP1_1} to time _{STOP1_2}. The time ΔT1 corresponds to an operation delay of the transceiver 151. The time ΔR1 corresponds to an operation delay of the receiver 154. The signal transmitting unit 11 acquires the delay time of the transceiver 151 by receiving the time ΔT1, and acquires the delay time of the receiver 154 by receiving the time ΔR1.

Also, in the non-measurement mode, the signal transmitting unit 21 sends the light emission signal _{START} to the measuring unit 24 and the transceiver 251. Upon receipt of the light emission signal _{START}, the measuring unit 24 starts measuring time. The transceiver 251 sends the received light emission signal _{START} to the switch 252. The switch 252 sends the received light emission signal _{START} to the measuring unit 24 using a branch wiring line between the switch 252 and the switch 253, and also sends the light emission signal _{START} to the switch 253. The switch 253 sends the received light emission signal _{START} to the receiver 254. The receiver 254 sends the received light emission signal _{START} to the switch 255. The switch 255 sends the received light emission signal _{START} to the measuring unit 24.

The time when the measuring unit 24 receives the light emission signal _{START} from the signal transmitting unit 211s set as time _{START2}. The time when the measuring unit 24 receives the light emission signal _{START} that is sent from the switch 252 without passing through the switch 253 is set as time _{STOP2_1}. The time when the measuring unit 24 receives the light emission signal _{START} from the switch 255 is set as time _{STOP1_2}.

The measuring unit 24 calculates the time ΔT2 from time _{START2} to time _{STOP2_1}. The measuring unit 24 also calculates the time ΔR2 from time _{STOP2_1} to time _{STOP2_2}. The time ΔT2 corresponds to an operation delay of the transceiver 251. The time ΔR2 corresponds to an operation delay of the receiver 254. The signal transmitting unit 21 acquires the delay time of the transceiver 251 by receiving the time ΔT2, and acquires the delay time of the receiver 254 by receiving the time ΔR2.

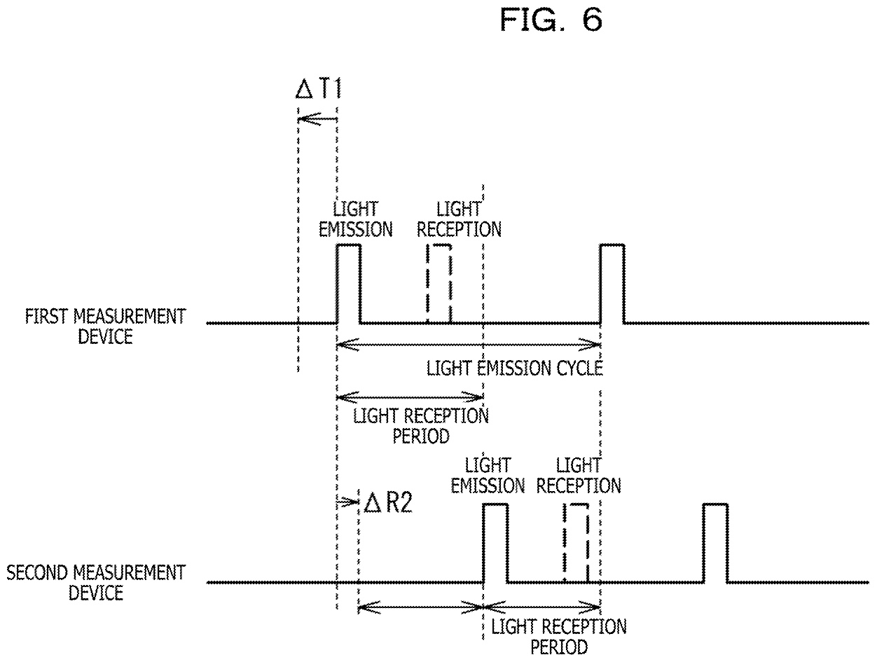

As illustrated in FIG. 6, after receiving the time ΔT1 and the time ΔR1, the signal transmitting unit 11 in the next measurement mode and later moves forward the timing for outputting the synchronization signal _{SYNCHRO} by the amount equivalent to the time ΔT1 from the timing for outputting the light emission signal _{START}. After receiving the time ΔT2 and the time ΔR2, the signal transmitting unit 21 in the next measurement mode and later starts the light reception period after the time equivalent to “light reception period −ΔR2” has passed since the reception of the synchronization signal from the first measurement device 10. Thus, the operation delay of the transceiver 151 and the operation delay of the receiver 254 can be offset, and a higher synchronization accuracy can be achieved.

Likewise, after receiving the time ΔT2 and the time ΔR2, the signal transmitting unit 21 in the next measurement mode and later moves forward the timing for outputting the synchronization signal _{SYNCHRO} by the amount equivalent to the time ΔT2 from the timing for outputting the light emission signal _{START}. After receiving the time ΔT1 and the time ΔR1, the signal transmitting unit 11 in the next measurement mode and later starts the light reception period after the time equivalent to “light reception period −ΔR1” has passed since the reception of the synchronization signal from the second measurement device 20. Thus, the operation delay of the transceiver 251 and the operation delay of the receiver 154 can be offset, and a higher synchronization accuracy can be achieved.

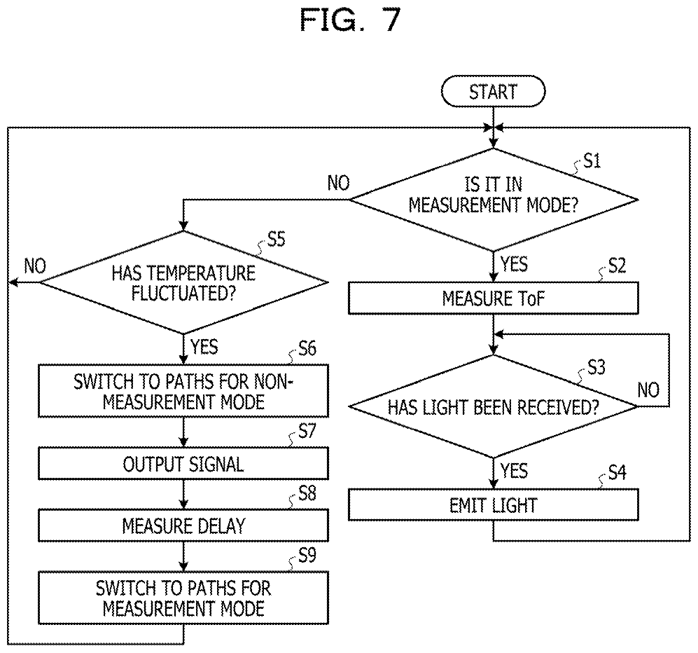

FIG. 7 is a flowchart showing an example operation of the first measurement device 10. As illustrated in FIG. 7, the signal transmitting unit 11 determines whether the measurement mode is set (step S1). If the result of the determination in step S1 is “Yes”, the signal transmitting unit 11 sends the light emission signal _{START} to the light emitting unit 12 and the measuring unit 14 at the start of the light reception period of the first measurement device 10 (step S2). Note that, at the time of execution of step S2, the signal transmitting unit 11 outputs the synchronization signal _{SYNCHRO} earlier than the timing for outputting the light emission signal _{START} by the amount equivalent to the time ΔT1.

Next, the light receiving unit 13 determines whether return light from the distance measurement target has been received (step S3). If the result of the determination in step S3 is “No”, step S3 is again carried out. If the result of the determination in step S3 is “Yes”, the light receiving unit 13 sends the stop signal so to the measuring unit 14, so that the measuring unit 14 calculates the distance from the light emitting unit 12 to the distance measurement target (step S4). After that, the operation described so far is again performed starting from step S1.

If the result of the determination in step S1 is “No”, the signal transmitting unit 11 determines whether the environment of the first measurement device 10 detected by the environment sensor 16 has fluctuated by an amount equal to or larger than a threshold value since a predetermined time ago (step S5). For example, the signal transmitting unit 11 may determine whether the temperature has fluctuated by 5° C. or more from the temperature five minutes ago. If the result of the determination in step S5 is “No”, the operation is again performed starting from step S1.

If the result of the determination in step S5 is “Yes”, the signal transmitting unit 11 switches the switches 152, 153, and 155 to the wiring paths for the non-measurement mode (step S6). Next, the signal transmitting unit 11 sends the light emission signal _{START} to the measuring unit 14 and the transceiver 151 (step S7). The measuring unit 14 then acquires the delay time of the transceiver 151 by receiving the time ΔT1, and acquires the delay time of the receiver 154 by receiving the time ΔR1 (step S8). The signal transmitting unit 11 then switches the switches 152, 153, and 155 to the wiring paths for the measurement mode (step S9). After that, the operation described so far is again performed starting from step S1.

The second measurement device 20 also operates according to the flowchart in FIG. 7, for example. Specifically, the signal transmitting unit 21 determines whether the measurement mode is set (step S1). If the result of the determination in step S1 is “Yes”, the signal transmitting unit 21 sends the light emission signal _{START} to the light emitting unit 22 and the measuring unit 24 at the start of the light reception period of the second measurement device 20 (step S2). Note that, at the time of execution of step S2, the signal transmitting unit 21 outputs the synchronization signal _{SYNCHRO} earlier than the timing for outputting the light emission signal _{START} by the amount equivalent to the time ΔT1.

Next, the light receiving unit 23 determines whether return light from the distance measurement target has been received (step S3). If the result of the determination in step S3 is “No”, step S3 is again carried out. If the result of the determination in step S3 is “Yes”, the light receiving unit 23 sends the stop signal _{STOP} to the measuring unit 24, so that the measuring unit 24 calculates the distance from the light emitting unit 22 to the distance measurement target (step S4). After that, the operation described so far is again performed starting from step S1.

If the result of the determination in step S1 is “No”, the signal transmitting unit 21 determines whether the environment of the second measurement device 20 detected by the environment sensor 26 has fluctuated by an amount equal to or larger than a threshold value since a predetermined time ago (step S5). For example, the signal transmitting unit 11 may determine whether the temperature has fluctuated by 5° C. or more from the temperature five minutes ago. If the result of the determination in step S5 is “No”, the operation is again performed starting from step S1.

If the result of the determination in step S5 is “Yes”, the signal transmitting unit 21 switches the switches 252, 253, and 255 to the wiring paths for the non-measurement mode (step S6). Next, the signal transmitting unit 21 sends the light emission signal _{START} to the measuring unit 24 and the transceiver 251 (step S7). The measuring unit 24 then acquires the delay time of the transceiver 251 by receiving the time ΔT2, and acquires the delay time of the receiver 254 by receiving the time ΔR2 (step S8). The signal transmitting unit 21 then switches the switches 252, 253, and 255 to the wiring paths for the measurement mode (step S9). After that, the operation described so far is again performed starting from step S1.

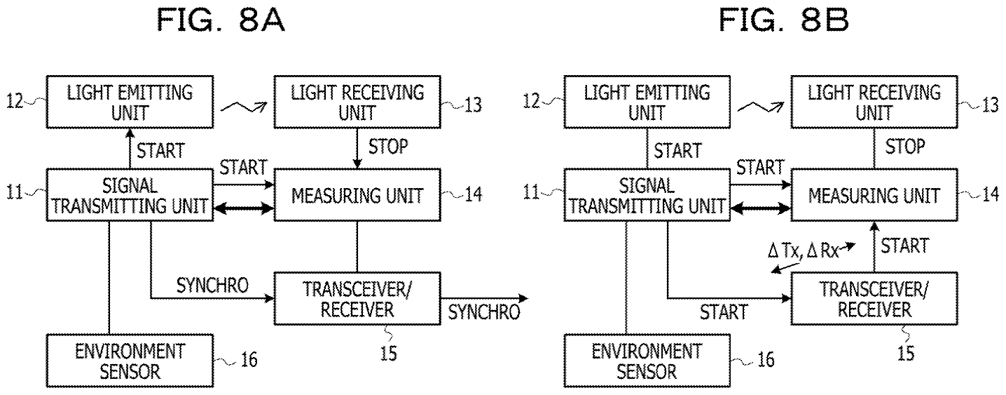

According to this embodiment, as illustrated in FIG. 8A, in the first measurement device 10, the signal transmitting unit 11 in the measurement mode sends the light emission signal _{START} to the light emitting unit 12 and the measuring unit 14, and the measuring unit 14 measures the distance to the distance measurement target in accordance with the time from the reception of the light emission signal _{START} to the reception of the stop signal _{STOP} output by the light receiving unit 13 having received the light returning from the distance measurement target after the light emitting unit 12 emits light toward the distance measurement target upon receipt of the light emission signal _{START}. In the non-measurement mode, as illustrated in FIG. 8B, a path is formed for the purpose of returning the light emission signal _{START} output by the signal transmitting unit 11 to the measuring unit 14 via the transceiver 151 in the transceiver/receiver 15 for sending the synchronization signal _{SYNCHRO} to an external measurement device. In the next and later measurement mode, the time difference between the time when the measuring unit 14 receives the light emission signal _{START} not through the transceiver 151 and the time when the measuring unit 14 receives the light emission signal _{START} via the transceiver 151 is reflected by the timing at which the signal transmitting unit 11 sends the synchronization signal to the transceiver 151. With this configuration, a higher synchronization accuracy can be achieved, and accordingly, a higher measurement accuracy can be achieved. For example, a synchronization accuracy on the order of picoseconds (ps) can be achieved. Further, it is possible to obtain information for improving synchronization accuracy simply by changing wiring paths. Accordingly, the components included in the first measurement device 10 can be effectively used. The same applies to the second measurement device.

Also, in the non-measurement mode, a path is formed for the purpose of returning the light emission signal _{START} output by the signal transmitting unit 11 to the measuring unit 14 via the receiver 154 of the transceiver/receiver 15. In the next and later measurement mode, the time difference between the time when the measuring unit 14 receives the light emission signal _{START} not through the receiver 154 and the time when the measuring unit 14 receives the light emission signal _{START} via the receiver 154 is reflected by the timing at which the signal transmitting unit 11 sends the light emission signal _{START} to the light emitting unit 12. With this configuration, a higher synchronization accuracy can be achieved, and accordingly, a higher measurement accuracy can be achieved. For example, a synchronization accuracy on the order of picoseconds (ps) can be achieved. Further, it is possible to obtain information for improving synchronization accuracy simply by changing wiring paths. Accordingly, the components included in the first measurement device 10 can be effectively used. The same applies to the second measurement device.

Note that a delay in a wiring line between the first measurement device 10 and the second measurement device 20 can be measured in advance. For example, a signal may be sent back and forth between the first measurement device 10 and the second measurement device 20, to measure a delay in a wiring line between the first measurement device 10 and the second measurement device 20. The measured delay may be reflected by the synchronization between the first measurement device 10 and the second measurement device 20.

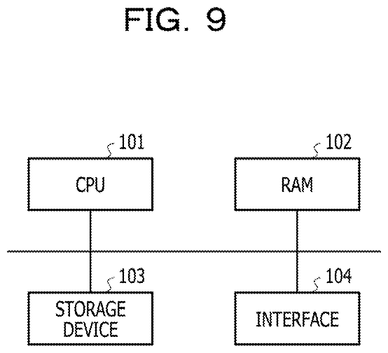

FIG. 9 is a block diagram for explaining the hardware configuration of the signal transmitting unit 11 and the measuring unit 14. The signal transmitting unit 21 and the measuring unit 24 also have the same configuration as that illustrated in FIG. 9. As illustrated in FIG. 9, the signal transmitting unit 11 and the measuring unit 14 include a CPU 101, a RAM 102, a storage device 103, and an interface 104, for example. These components are connected to one another by a bus or the like. The CPU 101 is a central processing unit. The CPU 101 includes one or more cores. The random access memory (RAM) 102 is a volatile memory that temporarily stores a program to be executed by the CPU 101, data to be processed by the CPU 101, and the like. The storage device 103 is a nonvolatile storage device. The storage device 103 may be a read only memory (ROM), a solid state drive (SSD) such as a flash memory, a hard disk to be driven by a hard disk drive, or the like, for example. As the CPU 101 executes the program stored in the storage device 103, the signal transmitting unit 11, the measuring unit 14, and the like are formed in the first measurement device 10. Note that the signal transmitting unit 11, the measuring unit 14, and the like may be formed with an integrated circuit such as an application specific integrated circuit (ASIC) or a field programmable gate array (FPGA).

In the above example, the light emission signal _{START} is an example of the first signal and the second signal. The signal transmitting units 11 and 21 are an example of the signal transmitting unit that sends the first signal to the light emitting unit and the measuring unit to instruct the light emitting unit to emit light, and sends a synchronization signal for a notification of light emission from the light emitting unit to the transceiver for sending the synchronization signal to an external measurement device. The measuring units 14 and 24 are an example of the measuring unit that measures the distance to the distance measurement target by measuring the time from the reception of the first signal. The switches 152 and 252 are an example of the path forming unit that forms the path for returning the second signal output by the signal transmitting unit to the measuring unit via the transceiver.

The signal transmitting units 11 and 21 are also an example of the signal transmitting unit that sends the first signal to the light emitting unit and the measuring unit to instruct the light emitting unit to emit light, at the timing according to the synchronization signal received from an external device via the receiver. The measuring units 14 and 24 are an example of the measuring unit that measures the distance to the distance measurement target by measuring the time since the time for receiving the first signal. The switches 152, 153, and 155, and the switches 252, 253, and 255 are an example of the path forming unit that forms the path for returning the second signal output by the signal transmitting unit to the measuring unit via the receiver.

(Modifications)

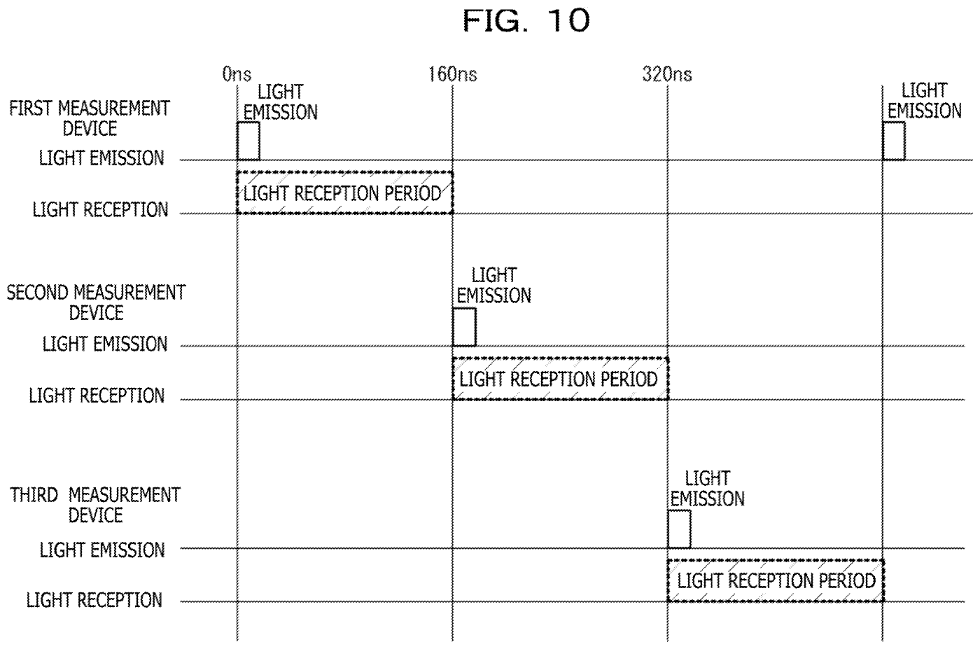

Although the synchronization between the first measurement device and the second measurement device 20 has been described in the first embodiment, the number of devices to be synchronized may be three or larger. For example, as illustrated in FIG. 10, measurement is carried out during the light reception period of a first measurement device, measurement is then carried out during the light reception period of a second measurement device, measurement is then carried out during the light reception period of a third measurement device, and measurement is then carried out during the light reception period of the first measurement device. In this manner, the number of devices may be three or larger. In this case, the synchronization signal output by the first measurement device is sent to the second measurement device, the synchronization signal output by the second measurement device is sent to the third measurement device, and the synchronization signal output by the third measurement device is sent to the first measurement device.

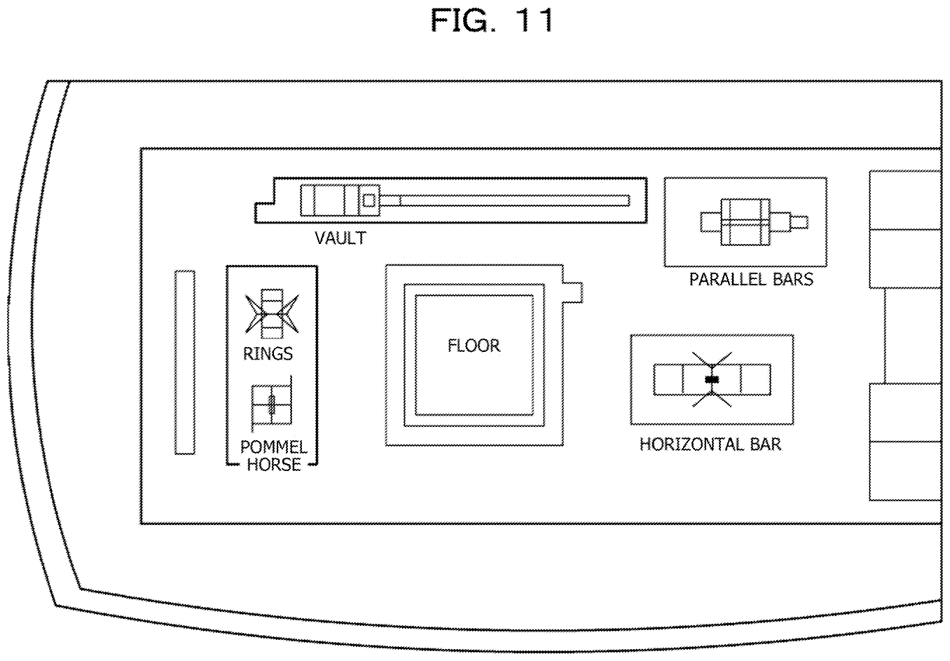

FIG. 11 is a diagram illustrating a gymnastics competition venue. As illustrated in FIG. 11, a floor, parallel bars, a horizontal bar, a vault, a pommel horse, rings, a balance beam, and the like are set in the gymnastics competition venue. The balance beam event is held at the same competition site as the pommel horse event and the rings event. A plurality of devices capable of measuring distances like the first measurement device 10 and the second measurement device 20 of the first embodiment is set in each competition site. With this arrangement, distance measurement can be conducted at various positions, angles, and the like for each competition. The results of the distance measurement can be used for giving scores and assisting the scoring in each competition.

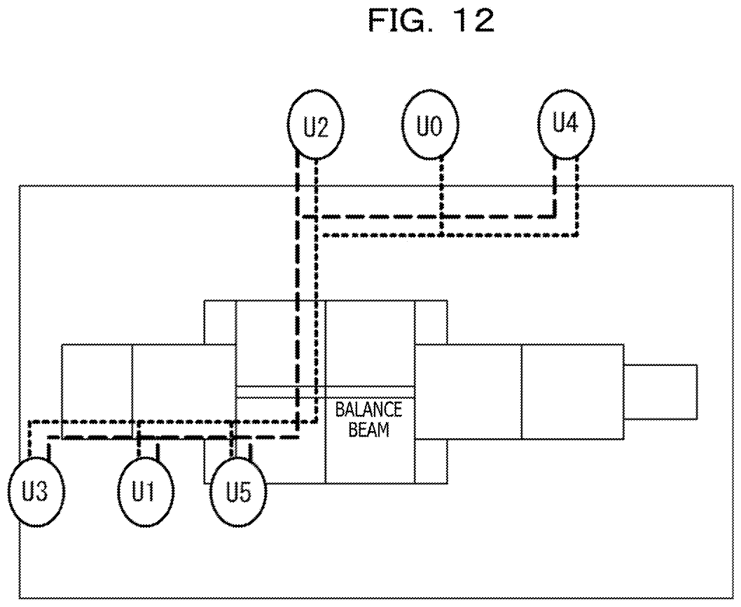

For example, as illustrated in FIG. 12, a plurality of measurement devices U0 to U5 capable of measuring distances is set around a balance beam, and the measurement devices U0 to U5 are connected to one another by wiring lines. Distance measurement is conducted in order from the measurement device U0 to the measurement device U5. When the measurement device U0 conducts distance measurement, the measurement devices U1 to U5 do not carry out any distance measurement. When the measurement device U1 next conducts distance measurement, the measurement devices U0 and U2 to U5 do not carry out any distance measurement. In this manner, distance measurement is conducted in a sequential manner.

The embodiment has been described in detail. However, the present embodiment is not limited to such a specific embodiment, and various modifications and alterations can be made within the scope of the embodiment disclosed in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A measurement method executed by a computer, comprising:
executing transmission processing and measuring processing, the transmission processing including a process of generating a first signal which instructs the measuring processing and light emitting processing, the measuring processing including a process of identifying a distance by measuring a time from a reception time of the first signal;
setting a path for causing the measuring processing to process a second signal output by the transmission processing via a transceiver for transmitting a synchronization signal, the synchronization signal being for notifying an external measurement device of a light emission output by the light emitting processing; and
identifying a timing for transmitting the synchronization signal output by the transmission processing based on a time difference between a time for receiving the second signal not through the transceiver and a time for receiving the second signal via the transceiver.

2. The measurement method according to claim 1, wherein
the second signal is same signal as the first signal, and
the method comprising setting a path for returning the first signal via the transceiver.

3. The measurement method according to claim 1, further comprising:
transmitting the first signal at a timing corresponding to a synchronization signal received from an external device via a receiver;
receiving the second signal via the receiver; and
identifying the timing for transmitting the first signal based on a difference between a time for receiving the second signal not through the receiver, and a time for receiving the second signal via the receiver.

4. A measurement method executed by a computer, the method comprising:
transmitting a first signal at a timing corresponding to a synchronization signal received from an external device via a receiver, the first signal being for issuing an instruction for light emission;
identify a distance to a distance measurement target by measuring time from a time of reception of the first signal;
setting a path for receiving a second signal via the receiver, the second signal being for issuing an instruction for the light emission; and
identifying the timing for transmitting the first signal based on a time difference between a time for receiving the second signal not through the receiver and a time for receiving the second signal via the receiver.

5. The measurement method according to claim 4, wherein the method comprising
outputting the second signal when an environment change detected by an environment sensor that detects a change in an ambient environment becomes equal to or larger than a threshold.

6. A measurement device, comprising:
a memory; and
a processor coupled to the memory and the processor configured to:
execute transmission processing and measuring processing, the transmission processing including a process of generating a first signal which instructs the measuring processing and light emitting processing, the measuring processing including a process of identifying a distance by measuring a time from a reception time of the first signal,
set a path for causing the measuring processing to process a second signal output by the transmission processing via a transceiver for transmitting a synchronization signal, the synchronization signal being for notifying an external measurement device of a light emission output by the light emitting processing; and
identify a timing for transmitting the synchronization signal output by the transmission processing based on a time difference between a time for receiving the second signal not through the transceiver and a time for receiving the second signal via the transceiver.

7. The measurement device according to claim 6, wherein
the second signal is same signal as the first signal, and
the processor configured to set a path for returning the first signal via the transceiver.

8. The measurement device according to claim 6, wherein the processor configured to:
transmit the first signal at a timing corresponding to a synchronization signal received from an external device via a receiver,
receive the second signal via the receiver, and
identify the timing for transmitting the first signal based on a difference between a time for receiving the second signal not through the receiver, and a time for receiving the second signal via the receiver.

9. A measurement device, comprising:
a memory; and
a processor coupled to the memory and the processor configured to:
transmit a first signal at a timing corresponding to a synchronization signal received from an external device via a receiver, the first signal being for issuing an instruction for light emission,
measure time from a time of reception of the first signal, to measure a distance to a distance measurement target,
set a path for receiving a second signal via the receiver, the second signal being for issuing an instruction for the light emission, and
Identify the timing for transmitting the first signal based on a time difference between a time for receiving the second signal not through the receiver and a time for receiving the second signal via the receiver.

10. The measurement device according to claim 9, wherein the processor configured to
output the second signal when an environment change detected by an environment sensor that detects a change in an ambient environment becomes equal to or larger than a threshold.

11. A non-transitory computer-readable storage medium storing a program that causes a computer to execute a process, the process comprising:
executing transmission processing and measuring processing, the transmission processing including a process of generating a first signal which instructs the measuring processing and light emitting processing, the measuring processing including a process of identifying a distance by measuring a time from a reception time of the first signal;
setting a path for causing the measuring processing to process a second signal output by the transmission processing via a transceiver for transmitting a synchronization signal, the synchronization signal being for notifying an external measurement device of a light emission output by the light emitting processing; and
identifying a timing for transmitting the synchronization signal output by the transmission processing based on a time difference between a time for receiving the second signal not through the transceiver and a time for receiving the second signal via the transceiver.

12. The non-transitory computer-readable storage medium according to claim 11, wherein
the second signal is same signal as the first signal, and
the method comprising setting a path for returning the first signal via the transceiver.

13. The non-transitory computer-readable storage medium according to claim 11, the method further comprising:
transmitting the first signal at a timing corresponding to a synchronization signal received from an external device via a receiver;
receiving the second signal via the receiver; and
identifying the timing for transmitting the first signal based on a difference between a time for receiving the second signal not through the receiver, and a time for receiving the second signal via the receiver.

14. A non-transitory computer-readable storage medium storing a program that causes a computer to execute a process, the process comprising:
transmitting a first signal at a timing corresponding to a synchronization signal received from an external device via a receiver, the first signal being for issuing an instruction for light emission;
identify a distance to a distance measurement target by measuring time from a time of reception of the first signal;
setting a path for receiving a second signal via the receiver, the second signal being for issuing an instruction for the light emission; and
identifying the timing for transmitting the first signal based on a time difference between a time for receiving the second signal not through the receiver and a time for receiving the second signal via the receiver.
